(19) United States
(12) Patent Application Publication
(10) Pub. No.: US 2026/0111694 A1
(43) Pub. Date: Apr. 23, 2026

(54) METHODS AND APPARATUS FOR COMMISSIONING MICROINVERTERS IN A PHOTOVOLTAIC SYSTEM

(71) Applicant: Enphase Energy, Inc., Petaluma, CA (US)

(72) Inventors: Garvit GOPAL, Prayagraj (IN); Amit KUMAR, Haryana (IN); Vidyasagar Venkata NALLAPATI, Bangalore (IN); Ashish BANSAL, Bengaluru (IN); Preetam PINNADA, Visakhapatnam (IN); Varanasi Vachan SIDDHARTH, Srikakulam (IN); Tharakeswar PENTAMSETTY, Vempalle (IN)

(21) Appl. No.: 19/360,318

(22) Filed: Oct. 16, 2025

(30) Foreign Application Priority Data
Oct. 22, 2024 (IN) 202411080296

(51) Int. Cl. G06K 7/14; G06K 19/06; H02S 99/00

(52) U.S. Cl. CPC G06K 7/1417; G06K 7/1443; G06K 7/1452; G06K 7/1456; G06K 7/1491; G06K 19/06037; H02S 99/00

(57) ABSTRACT

A method for commissioning a photovoltaic array is provided herein and comprises detecting, at a detector, a plurality of barcodes assigned to at least one of a photovoltaic or a microinverter in operative communication with the photovoltaic, outputting, from the detector, isolated individual barcode images of the plurality of barcodes to a reader, analyzing, at the reader, the isolated individual barcode images, and outputting, from the reader, a plurality of serial numbers corresponding to the isolated individual barcode images.

### CROSS-REFERENCE TO RELATED APPLICATIONS

The present application claims the benefit of and priority to Indian Provisional Application Serial No. 202411080296, filed on Oct. 22, 2024, the entire contents of which is incorporated herein by reference.

### BACKGROUND

### 1. Field of the Disclosure

Embodiments of the present disclosure generally relate to power conversion systems and, for example, to methods and apparatus for commissioning microinverters in a photovoltaic (PV) system.

### 2. Description of the Related Art

Conventional power conversion systems are known and can comprise a solar system that comprises one or more photovoltaics that can be coupled in a one-to-one correspondence to one or more microinverters. Commissioning of the one or more photovoltaics and/or the one or more microinverters is a critical aspect of solar system setup and can be essential for photovoltaic system performance and for longevity of equipment, safety, return on investment (ROI), and warranties. During a commissioning process, one step includes assigning the one or more microinverters with serial numbers. For example, an installer, typically, first creates a rough sketch of the solar system, sticks the barcode images on paper (or other suitable surface), and scans individual photos of the barcode images using, for example, a mobile application. Such a process can be error-prone and extremely time-consuming.

Therefore, described herein are improved methods and apparatus for commissioning microinverters in a photovoltaic system.

### SUMMARY

In accordance with some aspects of the present disclosure, there is provided a method for commissioning a photovoltaic array comprising detecting, at a detector, a plurality of barcodes assigned to at least one of a photovoltaic or a microinverter in operative communication with the photovoltaic, outputting, from the detector, isolated individual barcode images of the plurality of barcodes to a reader, analyzing, at the reader, the isolated individual barcode images, and outputting, from the reader, a plurality of serial numbers corresponding to the isolated individual barcode images.

In accordance with some aspects of the present disclosure, there is provided a non-transitory computer readable storage medium having instructions stored thereon that when executed by a processor performs a method for commissioning a photovoltaic array. The method comprises detecting, at a detector, a plurality of barcodes assigned to at least one of a photovoltaic or a microinverter in operative communication with the photovoltaic, outputting, from the detector, isolated individual barcode images of the plurality of barcodes to a reader, analyzing, at the reader, the isolated individual barcode images, and outputting, from the reader, a plurality of serial numbers corresponding to the isolated individual barcode images.

In accordance with some aspects of the present disclosure, there is provided an apparatus for commissioning a photovoltaic array comprising a processor programmed to detect, using a detector, a plurality of barcodes assigned to at least one of a photovoltaic or a microinverter in operative communication with the photovoltaic, output, from the detector, isolated individual barcode images of the plurality of barcodes to a reader, analyze, at the reader, the isolated individual barcode images, and output, from the reader, a plurality of serial numbers corresponding to the isolated individual barcode images.

Various advantages, aspects, and novel features of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is diagram of a flowchart of a Page-Scan algorithm for scanning serial numbers assigned to one or more photovoltaics and/or one or more microinverters of the system for power conversion of FIG. 1, in accordance with at least some embodiments of the present disclosure;

FIG. 3 is diagram of a sample outcome using the Page-Scan algorithm of FIG. 2, in accordance with at least some embodiments of the present disclosure;

FIG. 4 is diagram of a flowchart of a Page-Scan algorithm for scanning serial numbers assigned to one or more photovoltaics and/or one or more microinverters of the system for power conversion of FIG. 1, in accordance with at least some embodiments of the present disclosure;

FIG. 5 is diagram of a sample outcome using the Page-Scan algorithm of FIG. 4, in accordance with at least some embodiments of the present disclosure;

FIG. 6 is diagram of a flowchart of an application programming interface (API) design and integration for commissioning one or more photovoltaics and/or one or more microinverters of the system for power conversion of FIG. 1, in accordance with at least some embodiments of the present disclosure;

FIG. 7 is flowchart of a method for commissioning one or more photovoltaics and/or one or more microinverters using the Page-Scan algorithms of FIGS. 2 and 4, in accordance with at least some embodiments of the present disclosure; and

FIG. 8 is a diagram illustrating an example of an input for a model of an algorithm, in accordance with at least some embodiments of the present disclosure.

### DETAILED DESCRIPTION

In accordance with the present disclosure, described herein are improved methods and apparatus for commissioning microinverters in a photovoltaic system. For example, a method for commissioning a photovoltaic array comprises detecting, at a detector, a plurality of barcodes assigned to at least one of a photovoltaic or a microinverter in operative communication with the photovoltaic, outputting, from the detector, isolated individual barcode images of the plurality of barcodes to a reader, analyzing, at the reader, the isolated individual barcode images, and outputting, from the reader, a plurality of serial numbers corresponding to the isolated individual barcode images. The methods and apparatus described herein can commission microinverters in a photovoltaic system with limited or no error in a relatively short time, which can have a direct impact on cost, efficiency, and cost reduction to automation and can have an indirect effect on a commissioning experience and end-user experience.

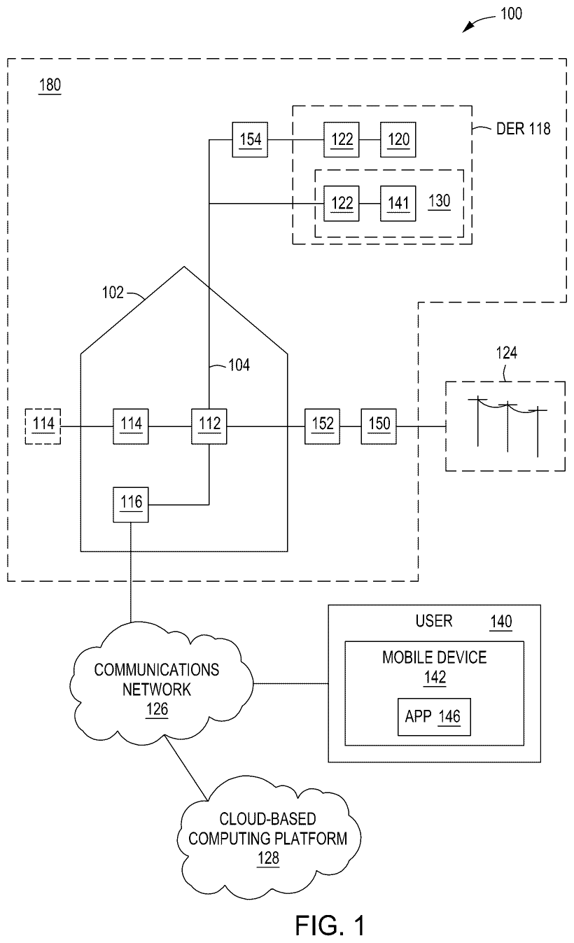

For example, FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home, commercial building, or separate mounting structure, having an associated DER 118 (distributed energy resource). The DER 118 is situated external to the structure 102. For example, the DER 118 may be located on the roof of the structure 102 or can be part of a solar farm. Alternatively, the DER 118 can be situated internal to the structure 102. For example, when the DER 118 is a permanent residential battery energy storage system, the DER 118 may be installed in a garage (or other suitable location inside the structure 102). The structure 102 comprises one or more loads and/or energy storage devices 114 (e.g., portable energy systems (PES), appliances, electric hot water heaters, thermostats/detectors, boilers, electric vehicle supply equipment (EVSE), EVs, water pumps, and the like), which can be located within or outside the structure 102, and a DER controller 116, each coupled to a load center 112. Although the energy storage devices 114, the DER controller 116, and the load center 112 are depicted as being located within the structure 102, one or more of these may be located external to the structure 102.

The load center 112 is coupled to the DER 118 by an AC bus 104 and is further coupled, via a meter 152 and optionally a MID 150 (microgrid interconnect device), to a grid 124 (e.g., a commercial/utility power grid). The structure 102, the energy storage devices 114, DER controller 116, DER 118, load center 112, generation meter 154, the meter 152, and the MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122 (e.g., microinverter, power converter, power conversion units (PCUs), etc.). For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a DC battery 141 may be referred to as an AC battery 130.

The power conditioners 122 invert the generated DC power from the plurality of RESs 120 and/or the DC battery 141 to AC power that is grid-compliant and couple the generated AC power to the grid 124 via the load center 112. The generated AC power may be additionally or alternatively coupled via the load center 112 to the one or more loads (e.g., EV, EVSE) and/or the energy storage devices 114. In addition, the power conditioners 122 that are coupled to the AC batteries convert AC power from the AC bus 104 to DC power for charging the AC batteries. A generation meter 154 is coupled at the output of the power conditioners 122 that are coupled to the plurality of RESs 120 in order to measure generated power.

In at least some embodiments, the power conditioners 122 may be AC-AC converters that receive AC input and convert one type of AC power to another type of AC power. Alternatively, the power conditioners 122 may be DC-DC converters that convert one type of DC power to another type of DC power. The DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein (e.g., the methods described herein).

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage. The meter 152 measures power flows independently of MID state, i.e., when MID is closed and DER's are connected to the grid and when MID is open and DER's are isolated from the grid.

The MID 150, which may also be referred to as an island interconnect device (IID), connects/disconnects the microgrid 180 to/from the grid 124. The MID 150 comprises a disconnect component (e.g., a relay, a contactor, or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications (e.g., a grid connectivity control application (an application 146)) installed thereon for controlling the connectivity with the grid 124 as described herein. The mobile device 142 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be managed differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

As noted above, improved methods and apparatus for commissioning microinverters in a photovoltaic system are described herein. For example, the methods and apparatus combine design solutions by adding a workflow of defining an array of photovoltaics and/or microinverters on an application and bulk scanning the individual part of the array. For example, for the bulk scanning, a format of page scan can be determined, and one or more computer vision techniques can be used to allow a user (installer) to scan multiple barcodes with a single scan (i.e., once) and create a complete array structure using only a few images. For example, given a snapshot of a sheet of paper (or other suitable substrate, such as cardboard, that can be configured to have the barcodes affixed to) with barcodes pasted on cells of the sheet of paper (e.g., rectangular placeholders for barcodes), the task is to detect the barcodes and read the serial numbers corresponding to the barcodes automatically to create an array inside application software for a user to keep track of. In at least some embodiments, the inventors have found that the Enlighten API (available from Enphase® Inc.) works extremely well with the algorithms described herein. For example, the algorithms described herein, which can be considered a Page-Scan algorithm, scan a page that contains all the barcodes.

For example, the inventors have found that the algorithm (e.g., the Page-Scan algorithm) can be broken down into a combination of two sub algorithms, a detection algorithm and a reading algorithm. For example, the detection algorithm can be configured for detection and isolation of barcodes on page (e.g., detection). In the detection algorithm, one or more various object detection techniques are used for treating a barcode as an object. For example, a pre-process is first used for straightening, contrast resolution, rotation, boundary edge detection, and the like, of a page-image. Next, the page image is scanned through a detector, which can be trained based on a required number of past images of barcodes that were pasted on a sheet of paper. Next, based on the detector's output (e.g., which can be mostly in the form of bounding boxes around barcodes), the individual barcode images are isolated and, subsequently, provided to the reading algorithm.

For example, the reading algorithm can be configured for reading the barcodes from the isolated images (e.g., reading). For example, as sharper barcode images are required for reading than for detection, the isolated barcode images are also pre-process after the detection process. For example, the reading algorithm is configured to rotate the isolated image to make the isolated image horizontal, reconstruction of damaged/blurry bars, contrast resolution, and the like. Next, the isolated processed images are fed to a reader to provide a final serial number.

The inventors have found that by using a total number of barcodes detected and read correctly across all images as a performance metric, a total accuracy can be calculated. For example, if there are 45/52 barcodes getting detected and read correctly in image 1 and 30/32 in another, then a total accuracy can be calculated using the following Equation (1):

$$( 45 + 30 ) / ( 52 + 32 ) = 89.28 \% . \qquad ( 1 )$$

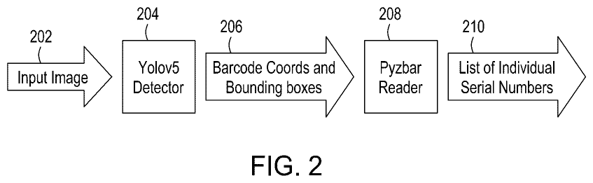

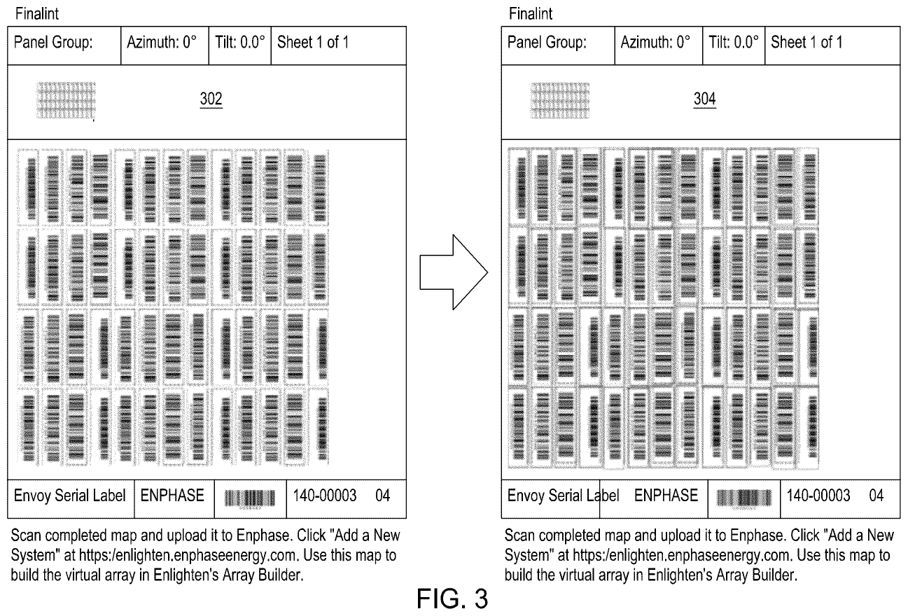

FIG. 2 is diagram of a flowchart of a Page-Scan algorithm for scanning serial numbers assigned to one or more photovoltaics and/or one or more microinverters of the system for power conversion of FIG. 1, and FIG. 3 is diagram of a sample outcome using the Page-Scan algorithm of FIG. 2, in accordance with at least some embodiments of the present disclosure. For example, in at least some embodiments, for detection and reading a Yolov5-Pyzbar approach can be used.

For example, regarding detection, a Yolov5 object detection algorithm can be used to detect and isolate all the barcodes from page (e.g., up to 52 barcodes on a single sheet of paper, see 202 and 204 of FIG. 2). Using the Yolov5 object detection algorithm, about around 200 images are trained with varied number of annotated barcodes, with different camera heights, levels of blurring and points of focus. Next, regarding reading, a Pyzbar library of Python with some level of contrast and brightness-based processing and filtering is used. For example, the Pyzbar library takes an image as input and parses the barcode image to obtain a serial number see 206, 208, and 210 of FIG. 2). The inventors have found that by using the Yolov5-Pyzbar approach, an accuracy of about 80% can be obtained. That is, about 80% of the total barcodes in all images were able to be detected, read, and outputted, so that the correct corresponding serial numbers can be obtained (see 302 and 304 of FIG. 3).

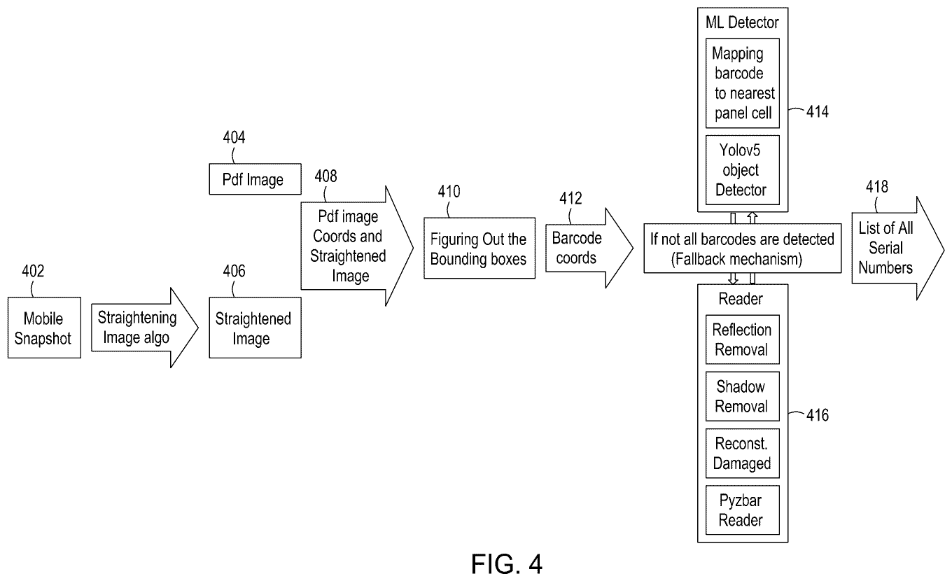

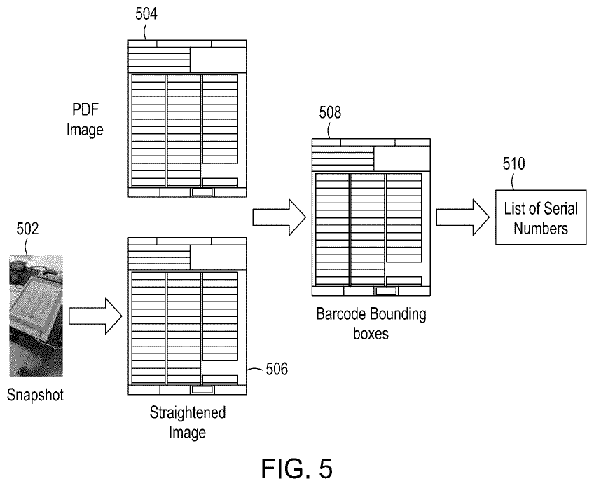

FIG. 4 is diagram of a flowchart of a Page-Scan algorithm for scanning serial numbers assigned to one or more photovoltaics and/or one or more microinverters of the system for power conversion of FIG. 1, and FIG. 5 is diagram of a sample outcome using the Page-Scan algorithm of FIG. 4, in accordance with at least some embodiments of the present disclosure. For example, in at least some embodiments, for detection and reading, a Dynamsoft approach (e.g., A4 sheet correction) can be used.

For example, regarding detection, exact coordinates of different barcode placeholders from a printed pdf sheet can be obtained. In at least some embodiments, a user (installer) can use fixed sheets to paste the barcodes in the designated areas, e.g., rectangular boxes. Next, a snapshot image (image taken by installer after pasting all the barcodes) uploaded by the installer to match the pdf coordinates can be corrected (see 402 and 404 of FIGS. 4 and 502 and 504 of FIG. 5). For example, correction can involve one or more steps including, but not limited to, straightening of the image by perspective correction algorithm, rotating to 0-degree angle to align exactly with the pdf sheet by degrees, and/or cropping to the aspect ratio of original pdf sheet (see 406 and 408 of FIG. 4 and 506 of FIG. 5). Since the exact coordinates of the original pdf sheet are already known, the barcodes can be isolated without having any layer of vision-based detector, which can provide increased accuracy of detection (see 410 and 412 of FIG. 4 and 508 of FIG. 5). Next. Regarding reading, a Dynamsoft barcode reader (e.g., 3^{rd} Party Barcode Reader Service) can be used, which the inventors have found had better accuracy than the Pyzbar reader. The isolated barcode images are pre-processed before passing them to Dynamsoft barcode reader. In at least some embodiments, the pre-processing step can comprise removing shadows and reflections and reconstruction of the barcode if distorted, and the list of serial numbers can be outputted (see 416 and 418 of FIG. 4 and 510 of FIG. 5). In at least some embodiments, one or more ML detectors can be used if all the barcodes are not detected (e.g., a fallback mechanism). For example, the Yolov5 object detector described above can be used as a fallback mechanism (see 414 of FIG. 4). In such embodiments, the barcode can be mapped to a nearest panel cell (e.g., photovoltaic cell). The inventors have found that by using the Dynamsoft approach, an accuracy of about 90% can be obtained. That is, about 90% of the total barcodes in all images were able to be detected, read, and outputted, so that the correct corresponding serial numbers can be obtained.

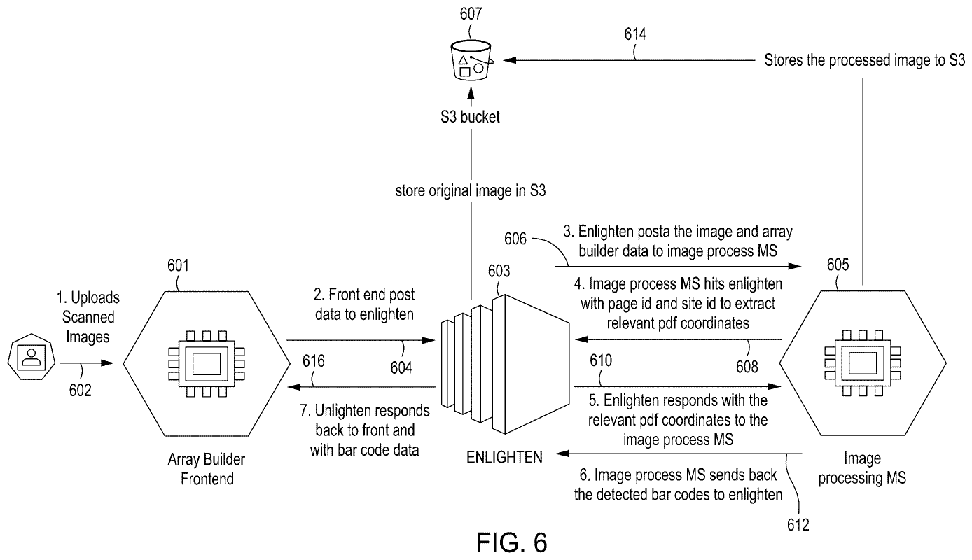

FIG. 6 is diagram of a flowchart of an application programming interface (API) design and integration for commissioning one or more photovoltaics and/or one or more microinverters of the system for power conversion of FIG. 1, in accordance with at least some embodiments of the present disclosure.

For example, a user can upload an image to a front end (see 602 of FIG. 6). In at least some embodiments, the front end can be a computing device (e.g., a smartphone, laptop, etc. in which the API is stored) is an array builder 601 and can provide an option to the user to draw a bounding box around the relevant part of the image.

Next, the front end posts the data to a gateway 603, which also comprises the API (see 604). For example, the front end posts the uploaded image and bounding box along with array builder pdf dimensions to the gateway, which can be in the form of multi-part form data. For example, the pdf dimensions can include a height and width of A1-A5 sheets, as they have the same aspect ratio (e.g., A4 sheet), and the absolute coordinates of every box where the barcodes are placed, which can also include a box in which the page id barcode is present. The front end also creates a unique ID (which is different from the IDs already created) for the page and posts the unique ID to the gateway.

The gateway 603 posts the image and array builder data to an image processing module MS 605. For example, the gateway 606 can validate a user and, if the validation passes, the gateway 603 posts the data to the image processing module MS 605. For the gateway 603 creates unique IDs (module IDs) for every box (except the page ID).

The image processing module MS 605 sends the gateway 603 the page ID and site ID to extract relevant pdf coordinates. For example, the image processing module MS 605 processes the image and finds the rectangular contour for the page ID barcode and reads the rectangular contour. The image processing module MS 605 sends the detected page ID to the gateway 603 to get the relevant coordinates of the bounding boxes (see 608).

The gateway 603 responds to the detected page ID with the relevant pdf coordinates to the image processing module MS 605. For example, the gateway 603 extracts the relevant bounding boxes for the given page ID and site ID and sends the relevant bounding boxes for the given page ID and site ID to the image processing module MS (see 610).

The image processing module MS 605 sends back the detected bar codes to the gateway 603. For example, the image processing module MS 605 processes the image and finds all the rectangular counters of the barcodes and scans them. For every successfully detected and scanned barcode, the image processing module MS 605 outputs the serial number and the corresponding ID of the rectangular contour to the gateway 603. Additionally, the image processing module MS 605 stores the processed image with the rectangular contours drawn to S3 (607) and sends back the serial numbers to the gateway 605 as a response (see 612).

The gateway 603 responds back to front end with bar code data. For example, the gateway 603 validates the detected bar codes and if the validations pass, the gateway 603 responds back to the front end with the serial numbers and the corresponding unique IDs (see 616).

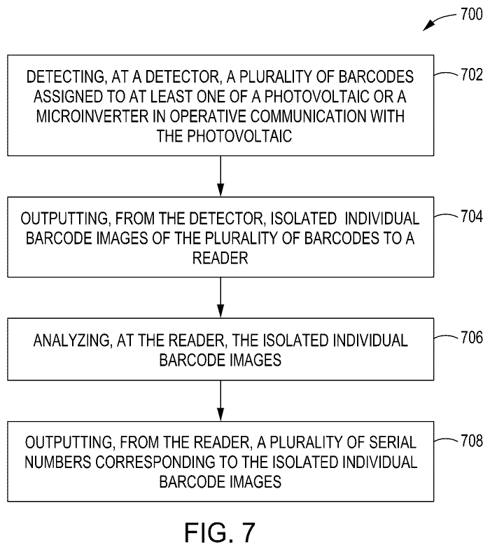

FIG. 7 is flowchart of a method for commissioning one or more photovoltaics and/or one or more microinverters using the Page-Scan algorithms of FIGS. 2 and 4, in accordance with at least some embodiments of the present disclosure. For example, in at least some embodiments, the method 700 can be used in conjunction with the API described in FIG. 6. For example, a user (e.g., the user 140, who can be an installer) can have the API (e.g., the application 146) stored on one or more front end computing devices (e.g., the mobile device 142, a scanner, or other suitable computing device). Additionally, a gateway (e.g., the DER controller 116) can also have the API stored thereon or the gateway can access the API on the cloud-based computing platform 158 using the communication network 126.

At 702, the method 700 can comprise detecting, at a detector, a plurality of barcodes assigned to at least one of a photovoltaic or a microinverter in operative communication with the photovoltaic. For example, as noted above, an installer can take a photo or scan the barcodes using one or more computing devices. Next, the user can transmit the images of the barcodes to a detection device, e.g., one or both of the detection devices/processes described above with respect to FIGS. 2-6. For example, the array builder 601 can be used to detect the scanned images and transmit the scanned images to the gateway 603. In at least some embodiments, 702 can comprise detecting the plurality of barcodes based on a learning algorithm (e.g., using the Yolov5-Pyzbar approach) having been trained with a plurality of images having at least one of a varied number of annotated barcodes or with different camera heights or with different levels of blurring and points of focus. Alternatively or additionally, 702 can comprise detecting the plurality of barcodes based on predetermined coordinates of different barcode placeholders (e.g., using the Dynamsoft Approach approach).

In at least some embodiments, the method 700 can comprise performing a first pre-process prior to detecting plurality of barcodes, as described above. In at least some embodiments, performing the first pre-process comprises at least one of straightening, contrast resolution, rotation, or boundary edge detection.

Next, at 704, the method 700 can comprise outputting, from the detector, isolated individual barcode images of the plurality of barcodes to a reader. For example, the gateway 603 can then transmit or post the scanned images to the image processing module MS 605.

Next, at 706, the method 700 can comprise analyzing, at the reader, the isolated individual barcode images, using one or both of the reading processes described above with respect to FIGS. 2-6. In at least some embodiments, the method 700 can comprise performing a second pre-process prior to analyzing the isolated individual barcode images. In at least some embodiments, performing the second pre-process comprises at least one of making the isolated individual barcode images horizontal, reconstructing damaged/blurry isolated individual barcode images, contrast resolution of the isolated individual barcode images.

Next, at 708, the method 700 comprises outputting, from the reader, a plurality of serial numbers corresponding to the isolated individual barcode images. For example, the image processing module MS 605 can transmit the plurality of serial numbers to the gateway 603 and/or to a storage device (e.g., S3). The gateway 603 can transmit the plurality of serial numbers to the mobile device 142 which can then display the plurality of serial numbers to the user.

In addition to the foregoing, one or more additional algorithms/methods may be used for bulk scanning and array building, e.g., greater than 100 power conditioning units (PCUs).

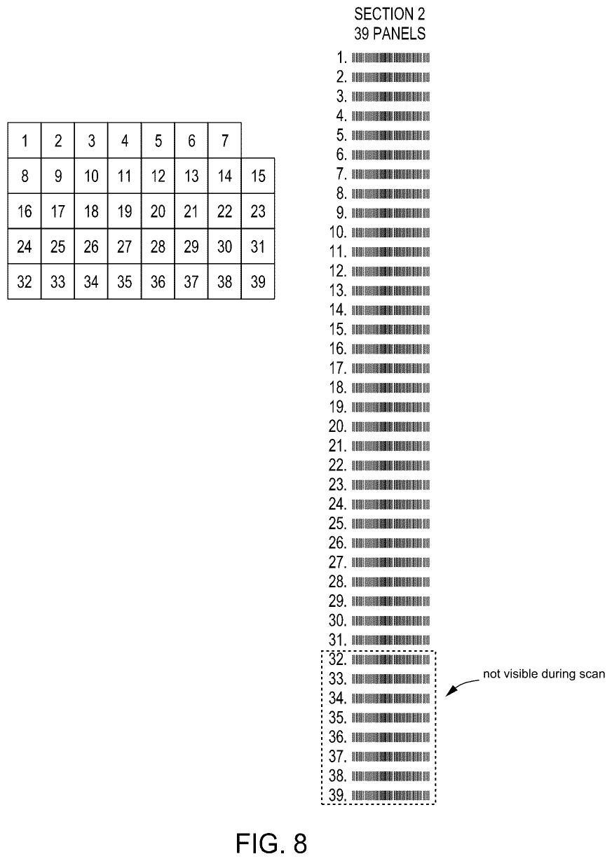

For example, a large language model (LLM) or large vision model (LVM), such as the Gemini 2.5 Flash-Image or Gemini 2.5 Pro, can be used to process an input image (see serial numbers associated with micro inverters of FIG. 8). The models can be built using transformer neural network architecture, which have demonstrated state-of-the-art performance in Image-text understanding and competitive performance in object detection. The models can be natively capable of optical character recognition (OCR) and can use of tools such as code-interpreter, which can execute LM-generated image editing scripts on the fly (in real-time). Additionally, using appropriate prompting and agentic loops, the capability and accuracy can be increased by an order of magnitude.

The previously described processing methods/operations (e.g., user input and cloud steps) can be used in conjunction with the large language model (LLM) or large vision model (LVM). For example, as noted above, an installer can take a photo or scan the barcodes using one or more computing devices. Next, the user can transmit the images of the barcodes to a detection device, e.g., one or both of the detection devices/processes described above with respect to FIGS. 2-6. For example, the array builder 601 can be used to detect the scanned images and transmit the scanned images to the gateway 603. Next, in at least some embodiments, all barcode values in the image can be listed and populated in a table according to the number location assigned to each barcode (see FIG. 8). Next, a table matching the structure of the grid shown in the image can be created, where a cell value can correspond to the barcode value of the associated cell number. In such embodiments, an AI module can be configured to forward the generated 2D-table output to a cloud array generation module (e.g., similar to 612), which can provide an output, such as the one illustrated in Table 1.

TABLE 1

| Panel Location | Panel Location | Panel Location | Panel Location | Panel Location |
|---|---|---|---|---|
| 32-39 | 24-31 | 16-23 | 8-15 | 1-7 |
| Not Visible | 202248119624 | 202248119534 | 202248119532 | 202248119495 |
| | (24) | (16) | (8) | (1) |
| Not Visible | 202248119616 | 202248120482 | 202248119632 | 202248119500 |
| | (25) | (17) | (9) | (2) |
| Not Visible | 202248119514 | 202248119394 | 202248119488 | 202248119502 |
| | (26) | (18) | (10) | (3) |
| Not Visible | 202248119448 | 202248119722 | 202248120058 | 202248119416 |
| | (27) | (19) | (11) | (4) |
| Not Visible | 202248119512 | 202248119482 | 202248119530 | 202248119418 |
| | (28) | (20) | (12) | (5) |
| Not Visible | 202248119424 | 202248120498 | 202248120464 | 202248119524 |
| | (29) | (21) | (13) | (6) |
| Not Visible | 202248120024 | 202248119506 | 202248119398 | 202248119504 |
| | (30) | (22) | (14) | (7) |
| Not Visible | 202248119556 | 202248119420 | 202248119456 | |
| | (31) | (23) | (15) | |

As illustrated in the Table 1 and considering the input of FIG. 8, specific locations on the array where the barcodes are unclear or not visible (e.g., 32-39) can be used to appropriately guide the end-user to re-scan the unclear or not visible barcodes (see microinverters in designated by phantom lines). In at least some embodiments, the accuracy of the method described with respect to FIG. 8 can further be improved by using/enforcing stricter I/O constraints, e.g., relating to length of scanned serial numbers, which can be about 12 digits, etc.

While the algorithms/methods associated with FIG. 8 enhanced the algorithms associated with FIGS. 2-7 (e.g., using the same barcode-based input images), alternative embodiments can replace the barcodes with QR codes in the input image prior to processing. In such embodiments, the QR codes occupies less space (e.g., 14×14 mm) compared to a barcode (e.g., 14×70 mm) on a A4-sheet grid (or cardboard), thereby accommodating (5-times) more devices in a given image or scan. Additionally, unlike traditional one dimensional barcodes, which can fail even if a small part the barcode is unreadable, QR codes are designed with data redundancy, which can be achieved, for example, using the Reed-Solomon error correction algorithm, which intersperses duplicate data within the code's structure. Thus, a QR code can sustain significant damage—such as being torn, smudged, or having a portion obscured—and still be perfectly readable. Such an error correction can be available at four distinct levels. For example, a Level L (Low) can restore up to 7% of damaged data. A Level M (Medium) can restore up to 15% of damaged data. A Level Q (Quartile) can restore up to 25% of damaged data. A Level H (High) can restore up to 30% of damaged data.

Moreover, in at least some embodiments, a near field communication tag (NFC) can be used for (e.g., attached to) each microinverter during manufacturing. For example, a twelve (12)-digit number (e.g., a device serial number), typically, requires about 15-20 bytes of memory (including formatting overhead). In such instances, a common and cost-effective chip that can be used can be the NTAG213 chip, which can offer 144 bytes of usable memory (more than enough memory), and the NTAG213 chip mass production makes the NTAG213 chip relatively cheap (about $0.19-0.4) and most widely available option for basic NFC stickers. Further, a barcode and/or a QR-code can optionally be printed on the NFC stickers, thus, making the NFC stickers backward compatible with older installation workflows.

In at least some embodiments, during device manufacturing, an auto-generated device serial number (e.g., barcode or QR-code) can be printed on and programmed into an NFC tag sticker, which can then be attached to the device (microinverter), packaged, and, subsequently, shipped.

In at least some embodiments, during array planning before physical installation, an installer/technician (e.g., in the back-office using Enlighten Manager) or on the site (e.g., using Enphase installer toolkit (ITK) app) can create an array according to the roof-top panel placement plan. Each panel in an array can be auto-assigned a monotonically increasing sequence number and the array plan can be synced to cloud (e.g., Enlighten cloud).

In at least some embodiments, during installation, an installer/technician, who install panels and microinverters on the rooftop, can carry a compact, wearable Bluetooth NFC reader paired with the mobile device 142. The NFC reader automatically captures the device serial number when brought near the NFC tag affixed to a microinverter. At the start of the physical installation, the installer/technician can launch the ITK app, download the array plan, connect the NFC reader to the mobile device 142, and initiate the scanning process. As each microinverter is installed, the installer/technician scans the microinverter NFC tag using the reader, as described above. Alternatively or additionally, the installer/technician may opt for bulk scanning at the end of the installation by sliding a batch scanner over all NFC tags arranged on a sheet of paper (or cardboard), e.g., in the sequence of their assigned numbers.

In at least some embodiments, the Enlighten cloud via ITK app can receive the raw output of NFC scans in one or more formats, e.g., sequence_number and/or serial_number. For example, the Enlighten cloud can complete the array building activity by auto-assigning serial numbers to array locations based on the sequence numbers.

While the foregoing is directed to embodiments of the present disclosure, other and further embodiments of the disclosure may be devised without departing from the basic scope thereof, and the scope thereof is determined by the claims that follow.

1. A method for commissioning a photovoltaic array, comprising:
detecting, at a detector, a plurality of barcodes assigned to at least one of a photovoltaic or a microinverter in operative communication with the photovoltaic;
outputting, from the detector, isolated individual barcode images of the plurality of barcodes to a reader;
analyzing, at the reader, the isolated individual barcode images; and
outputting, from the reader, a plurality of serial numbers corresponding to the isolated individual barcode images.

2. The method of claim 1, further comprising performing a first pre-process prior to detecting plurality of barcodes.

3. The method of claim 2, wherein performing the first pre-process comprises at least one of straightening, contrast resolution, rotation, or boundary edge detection.

4. The method of claim 1, further comprising performing a second pre-process prior to analyzing the isolated individual barcode images.

5. The method of claim 4, wherein performing the second pre-process comprises at least one of making the isolated individual barcode images horizontal, reconstructing damaged/blurry isolated individual barcode images, contrast resolution of the isolated individual barcode images.

6. The method of claim 1, wherein detecting the plurality of barcodes is based on a learning algorithm having been trained with a plurality of images having at least one of a varied number of annotated barcodes or with different camera heights or with different levels of blurring and points of focus.

7. The method of claim 1, wherein detecting the plurality of barcodes is based on predetermined coordinates of different barcode placeholders.

8. A non-transitory computer readable storage medium having instructions stored thereon that when executed by a processor performs a method for commissioning a photovoltaic array, comprising:
detecting, at a detector, a plurality of barcodes assigned to at least one of a photovoltaic or a microinverter in operative communication with the photovoltaic;
outputting, from the detector, isolated individual barcode images of the plurality of barcodes to a reader;
analyzing, at the reader, the isolated individual barcode images; and
outputting, from the reader, a plurality of serial numbers corresponding to the isolated individual barcode images.

9. The non-transitory computer readable storage medium of claim 8, further comprising performing a first pre-process prior to detecting plurality of barcodes.

10. The non-transitory computer readable storage medium of claim 9, wherein performing the first pre-process comprises at least one of straightening, contrast resolution, rotation, or boundary edge detection.

11. The non-transitory computer readable storage medium of claim 8, further comprising performing a second pre-process prior to analyzing the isolated individual barcode images.

12. The non-transitory computer readable storage medium of claim 11, wherein performing the second pre-process comprises at least one of making the isolated individual barcode images horizontal, reconstructing damaged/blurry the isolated individual barcode images, contrast resolution of the isolated individual barcode images.

13. The non-transitory computer readable storage medium of claim 8, wherein detecting the plurality of barcodes is based on a learning algorithm having been trained with a plurality of images having at least one of a varied number of annotated barcodes or with different camera heights or with different levels of blurring and points of focus.

14. The non-transitory computer readable storage medium of claim 8, wherein detecting the plurality of barcodes is based on predetermined coordinates of different barcode placeholders.

15. An apparatus for commissioning a photovoltaic array, comprising:
a processor programmed to:
detect, using a detector, a plurality of barcodes assigned to at least one of a photovoltaic or a microinverter in operative communication with the photovoltaic;
output, from the detector, isolated individual barcode images of the plurality of barcodes to a reader;
analyze, at the reader, the isolated individual barcode images; and
output, from the reader, a plurality of serial numbers corresponding to the isolated individual barcode images.

16. The apparatus of claim 15, wherein the processor is further programmed to perform a first pre-process prior to detecting plurality of barcodes.

17. The apparatus of claim 16, wherein the first pre-process comprises at least one of straightening, contrast resolution, rotation, or boundary edge detection.

18. The apparatus of claim 15, wherein the processor is further programmed to perform a second pre-process prior to analyzing the isolated individual barcode images.

19. The apparatus of claim 18, wherein the second pre-process comprises at least one of making the isolated individual barcode images horizontal, reconstructing damaged/blurry the isolated individual barcode images, contrast resolution of the isolated individual barcode images.

20. The apparatus of claim 15, wherein the processor is programmed to detect the plurality of barcodes based on a learning algorithm having been trained with a plurality of images having at least one of a varied number of annotated barcodes or with different camera heights or with different levels of blurring and points of focus.
